(19) United States
(12) Patent Application Publication
(10) Pub. No.: US 2020/0235797 A1
(43) Pub. Date: Jul. 23, 2020

(54) METHOD AND APPARATUS FOR PERFORMING CSI REPORTING ON BASIS OF SUBBAND GROUP

(71) Applicant: LG ELECTRONICS INC., Seoul (KR)

(72) Inventors: Hyungtae KIM, Seoul (KR); Kunil YUM, Seoul (KR); Jiwon KANG, Seoul (KR); Haewook PARK, Seoul (KR)

(21) Appl. No.: 16/652,347

(22) PCT Filed: Sep. 28, 2018
(86) PCT No.: PCT/KR2018/011549

§ 371 Date: Mar. 30, 2020

Related U.S. Application Data
(60) Provisional application No. 62/565,127, filed on Sep. 29, 2017.

(51) Int. Cl. H04B 7/06; H04L 5/00; H04W 80/08; H04W 8/24; H04B 17/336

(52) U.S. Cl. CPC H04B 7/0626; H04L 5/0094; H04B 17/336; H04W 8/24; H04B 7/0632; H04W 80/08

(57) ABSTRACT

The present disclosure relates to a method for reporting channel state information (CSI) in a wireless communication system, which is performed by a terminal, including: receiving information on CSI reporting timing from a base station; receiving, from the base station, first control information, which is information on a frequency region to be subject to subband reporting and second control information, which is information on a maximum number of subbands to be subject to subband reporting; receiving, from the base station, information on a subband starting position for setting a subband group; setting an interval between subbands based on the first control information and the second control information; setting a subband group based on an interval between the starting position and the interval between the subbands; and performing CSI reporting of the set subband group, in which the subband group is a subband to be subject to CSI reporting in the subbands.

### TECHNICAL FIELD

The present disclosure relates to a wireless communication system, and more particularly, to a method and an apparatus for performing CSI reporting based on a subband group.

### BACKGROUND ART

Mobile communication systems have been developed to provide voice services, while guaranteeing user activity. Service coverage of mobile communication systems, however, has extended even to data services, as well as voice services, and currently, an explosive increase in traffic has resulted in shortage of resource and user demand for a high speed services, requiring advanced mobile communication systems.

The requirements of the next-generation mobile communication system may include supporting huge data traffic, a remarkable increase in the transfer rate of each user, the accommodation of a significantly increased number of connection devices, very low end-to-end latency, and high energy efficiency. To this end, various techniques, such as small cell enhancement, dual connectivity, massive Multiple Input Multiple Output (MIMO), in-band full duplex, non-orthogonal multiple access (NOMA), supporting super-wide band, and device networking, have been researched.

### DISCLOSURE

### Technical Problem

The present disclosure provides a method for performing CSI reporting.

Furthermore, the present disclosure provides a method for determining an interval between subbands based on CSI reporting timing.

Furthermore, the present disclosure provides setting a subband group based on the interval.

Furthermore, the present disclosure provides a method for performing CSI reporting in the subband group.

The technical objects of the present disclosure are not limited to the aforementioned technical objects, and other technical objects, which are not mentioned above, will be apparently appreciated by a person having ordinary skill in the art from the following description.

### Technical Solution

The present disclosure provides a method for setting a subband based on CSI reporting timing in a wireless communication system.

Specifically, a method for reporting channel state information (CSI) in a wireless communication system, which is performed by a terminal, includes: receiving information on CSI reporting timing from a base station; receiving, from the base station, first control information, which is information on a frequency region to be subject to subband reporting and second control information, which is information on a maximum number of subbands to be subject to subband reporting; receiving, from the base station, information on a subband starting position for setting a subband group; setting an interval between subbands based on the first control information and the second control information; setting a subband group based on an interval between the starting position and the interval between the subbands; and performing CSI reporting of the set subband group, in which the subband group is a subband to be subject to CSI reporting in the subbands.

Furthermore, in the present disclosure, the method further includes: receiving, from the base station, information on a subband size to be used for the CSI reporting through a higher-layer signaling, in which the subband group is determined based on the subband size.

Furthermore, in the present disclosure, the second control information is determined based on the received CSI-reporting timing.

Furthermore, in the present disclosure, the interval is floor (first control information/second control information).

Furthermore, in the present disclosure, the method further includes: transmitting capability information of the terminal; receiving a reference value of SINR or CQI from a base station; and measuring the SINR or CQI of a subband, in which in the setting of the subband group, the measured SINR or CQI and the reference value are compared with each other to set a subband in which the measured SINR or CQI is equal to or larger than the reference value as a subband group.

Furthermore, in the present disclosure, whether to set the subband group is determined based on the capability of the terminal and the received CSI timing.

Furthermore, the present disclosure provides a terminal for performing a method for setting a subband group to be subject to CSI reporting based on CSI reporting timing in a wireless communication system, which includes: a radio frequency (RF) module transmitting and receiving a radio signal; and a processor functionally connected with the RF module, in which the processor is configured to receive information on CSI reporting timing from a base station, receive, from the base station, first control information, which is information on a frequency region to be subject to subband reporting and second control information, which is information on a maximum number of subbands to be subject to subband reporting, receive, from the base station, information on a subband starting position for setting a subband group, set an interval between subbands based on the first control information and the second control information, set a subband group based on an interval between the starting position and the interval between the subbands, and perform CSI reporting of the set subband group.

Furthermore, in the present disclosure, the processor is configured to receive, from the base station, information on a subband size to be used for the CSI reporting through a higher-layer signaling, and the subband group is determined based on the subband size.

Furthermore, in the present disclosure, the second control information is determined based on the received CSI-reporting timing.

Furthermore, in the present disclosure, the interval is floor (first control information/second control information).

Furthermore, in the present disclosure, the processor is configured to transmit capability information of the terminal, receive a reference value of SINR or CQI from a base station, and measure the SINR or CQI of a subband, and in the setting of the subband group, the measured SINR or CQI and the reference value are compared with each other to set a subband in which the measured SINR or CQI is equal to or larger than the reference value as a subband group.

Furthermore, in the present disclosure, whether to set the subband group is determined based on the capability of the terminal and the received CSI timing.

### Advantageous Effects

According to the present disclosure, there is an effect that a subband group is set based on CSI reporting timing to efficiently enable CSI reporting even for short CSI reporting timing.

Effects obtainable in the present disclosure are not limited to the aforementioned effects and other unmentioned effects will be clearly understood by those skilled in the art from the following description.

### DESCRIPTION OF DRAWINGS

The accompanying drawings, which are included herein as a part of the description for help understanding the present invention, provide embodiments of the present invention, and describe the technical features of the present invention with the description below.

FIG. 1 illustrates the structure of a radio frame in a wireless communication system to which the present invention may be applied.

FIG. 2 is a diagram illustrating a resource grid for a downlink slot in a wireless communication system to which the present invention may be applied.

FIG. 3 illustrates a structure of downlink subframe in a wireless communication system to which the present invention may be applied.

FIG. 4 illustrates a structure of uplink subframe in a wireless communication system to which the present invention may be applied.

FIG. 5 is a diagram illustrating an example of CSI feedback timing to which the present disclosure may be applied.

FIG. 6 is a diagram illustrating a subband group structure to which the present disclosure may be applied.

FIG. 7 is a flowchart illustrating an operation method of a UE performing CSI-RS reporting to which the present disclosure may be applied.

FIG. 8 is a block diagram of a wireless communication device according to an embodiment of the present disclosure.

### MODE FOR INVENTION

Some embodiments of the present invention are described in detail with reference to the accompanying drawings. A detailed description to be disclosed along with the accompanying drawings are intended to describe some embodiments of the present invention and are not intended to describe a sole embodiment of the present invention. The following detailed description includes more details in order to provide full understanding of the present invention. However, those skilled in the art will understand that the present invention may be implemented without such more details.

In some cases, in order to avoid that the concept of the present invention becomes vague, known structures and devices are omitted or may be shown in a block diagram form based on the core functions of each structure and device.

In this specification, a base station has the meaning of a terminal node of a network over which the base station directly communicates with a device. In this document, a specific operation that is described to be performed by a base station may be performed by an upper node of the base station according to circumstances. That is, it is evident that in a network including a plurality of network nodes including a base station, various operations performed for communication with a device may be performed by the base station or other network nodes other than the base station. The base station (BS) may be substituted with another term, such as a fixed station, a Node B, an eNB (evolved-NodeB), a Base Transceiver System (BTS), or an access point (AP). Furthermore, the device may be fixed or may have mobility and may be substituted with another term, such as User Equipment (UE), a Mobile Station (MS), a User Terminal (UT), a Mobile Subscriber Station (MSS), a Subscriber Station (SS), an Advanced Mobile Station (AMS), a Wireless Terminal (WT), a Machine-Type Communication (MTC) device, a Machine-to-Machine (M2M) device, or a Device-to-Device (D2D) device.

Hereinafter, downlink (DL) means communication from an eNB to UE, and uplink (UL) means communication from UE to an eNB. In DL, a transmitter may be part of an eNB, and a receiver may be part of UE. In UL, a transmitter may be part of UE, and a receiver may be part of an eNB.

Specific terms used in the following description have been provided to help understanding of the present invention, and the use of such specific terms may be changed in various forms without departing from the technical sprit of the present invention.

The following technologies may be used in a variety of wireless communication systems, such as Code Division Multiple Access (CDMA), Frequency Division Multiple Access (FDMA), Time Division Multiple Access (TDMA), Orthogonal Frequency Division Multiple Access (OFDMA), Single Carrier Frequency Division Multiple Access (SC-FDMA), and Non-Orthogonal Multiple Access (NOMA). CDMA may be implemented using a radio technology, such as Universal Terrestrial Radio Access (UTRA) or CDMA2000. TDMA may be implemented using a radio technology, such as Global System for Mobile communications (GSM)/General Packet Radio Service (GPRS)/Enhanced Data rates for GSM Evolution (EDGE). OFDMA may be implemented using a radio technology, such as Institute of Electrical and Electronics Engineers (IEEE) 802.11 (Wi-Fi), IEEE 802.16 (WiMAX), IEEE 802.20, or Evolved UTRA (E-UTRA). UTRA is part of a Universal Mobile Telecommunications System (UMTS). 3rd Generation Partnership Project (3GPP) Long Term Evolution (LTE) is part of an Evolved UMTS (E-UMTS) using evolved UMTS Terrestrial Radio Access (E-UTRA), and it adopts OFDMA in downlink and adopts SC-FDMA in uplink. LTE-Advanced (LTE-A) is the evolution of 3GPP LTE.

Embodiments of the present invention may be supported by the standard documents disclosed in at least one of IEEE 802, 3GPP, and 3GPP2, that is, radio access systems. That is, steps or portions that belong to the embodiments of the present invention and that are not described in order to clearly expose the technical spirit of the present invention may be supported by the documents. Furthermore, all terms disclosed in this document may be described by the standard documents.

In order to more clarify a description, 3GPP LTE/LTE-A is chiefly described, but the technical characteristics of the present invention are not limited thereto.

General System to which the Present Invention May be Applied

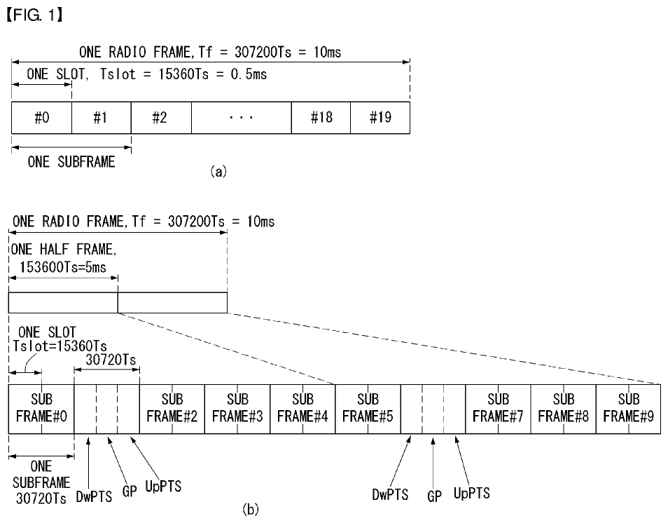

FIG. 1 shows the structure of a radio frame in a wireless communication system to which an embodiment of the present invention may be applied.

3GPP LTE/LTE-A support a radio frame structure type 1 which may be applicable to Frequency Division Duplex (FDD) and a radio frame structure which may be applicable to Time Division Duplex (TDD).

The size of a radio frame in the time domain is represented as a multiple of a time unit of T_s=1/(15000*2048). A UL and DL transmission includes the radio frame having a duration of T_f=307200*T_s=10 ms.

FIG. 1(a) exemplifies a radio frame structure type 1. The type 1 radio frame may be applied to both of full duplex FDD and half duplex FDD.

A radio frame includes 10 subframes. A radio frame includes 20 slots of T_slot=15360*T_s=0.5 ms length, and 0 to 19 indexes are given to each of the slots. One subframe includes consecutive two slots in the time domain, and subframe i includes slot 2i and slot 2i+1. The time required for transmitting a subframe is referred to as a transmission time interval (TTI). For example, the length of the subframe i may be 1 ms and the length of a slot may be 0.5 ms.

A UL transmission and a DL transmission I the FDD are distinguished in the frequency domain. Whereas there is no restriction in the full duplex FDD, a UE may not transmit and receive simultaneously in the half duplex FDD operation.

One slot includes a plurality of Orthogonal Frequency Division Multiplexing (OFDM) symbols in the time domain and includes a plurality of Resource Blocks (RBs) in a frequency domain. In 3GPP LTE, OFDM symbols are used to represent one symbol period because OFDMA is used in downlink. An OFDM symbol may be called one SC-FDMA symbol or symbol period. An RB is a resource allocation unit and includes a plurality of contiguous subcarriers in one slot.

FIG. 1(b) shows frame structure type 2.

A type 2 radio frame includes two half frame of 153600*T_s=5 ms length each. Each half frame includes 5 subframes of 30720*T_s=1 ms length.

In the frame structure type 2 of a TDD system, an uplink-downlink configuration is a rule indicating whether uplink and downlink are allocated (or reserved) to all subframes.

Table 1 shows the uplink-downlink configuration.

TABLE 1

| Uplink- | Downlink- | | | | | | | | | | | |
|---|---|---|---|---|---|---|---|---|---|---|---|---|
| Downlink | to-Uplink | | | | | | | | | | | |
| config- | Switch-point | | Subframe number | | | | | | | | | |
| uration | periodicity | | 0 | 1 | 2 | 3 | 4 | 5 | 6 | 7 | 8 | 9 |
| 0 | 5 | ms | D | S | U | U | U | D | S | U | U | U |
| 1 | 5 | ms | D | S | U | U | D | D | S | U | U | D |
| 2 | 5 | ms | D | S | U | D | D | D | S | U | D | D |
| 3 | 10 | ms | D | S | U | U | U | D | D | D | D | D |
| 4 | 10 | ms | D | S | U | U | D | D | D | D | D | D |
| 5 | 10 | ms | D | S | U | D | D | D | D | D | D | D |
| 6 | 5 | ms | D | S | U | U | U | D | S | U | U | D |

Referring to Table 1, in each subframe of the radio frame, ‘D’ represents a subframe for a DL transmission, ‘U’ represents a subframe for UL transmission, and ‘S’ represents a special subframe including three types of fields including a Downlink Pilot Time Slot (DwPTS), a Guard Period (GP), and a Uplink Pilot Time Slot (UpPTS).

A DwPTS is used for an initial cell search, synchronization or channel estimation in a UE. A UpPTS is used for channel estimation in an eNB and for synchronizing a UL transmission synchronization of a UE. A GP is duration for removing interference occurred in a UL owing to multi-path delay of a DL signal between a UL and a DL.

Each subframe i includes slot 2i and slot 2i+1 of T_slot=15360*T_s=0.5 ms.

The UL-DL configuration may be classified into 7 types, and the position and/or the number of a DL subframe, a special subframe and a UL subframe are different for each configuration.

A point of time at which a change is performed from downlink to uplink or a point of time at which a change is performed from uplink to downlink is called a switching point. The periodicity of the switching point means a cycle in which an uplink subframe and a downlink subframe are changed is identically repeated. Both 5 ms and 10 ms are supported in the periodicity of a switching point. If the periodicity of a switching point has a cycle of a 5 ms downlink-uplink switching point, the special subframe S is present in each half frame. If the periodicity of a switching point has a cycle of a 5 ms downlink-uplink switching point, the special subframe S is present in the first half frame only.

In all the configurations, 0 and 5 subframes and a DwPTS are used for only downlink transmission. An UpPTS and a subframe subsequent to a subframe are always used for uplink transmission.

Such uplink-downlink configurations may be known to both an eNB and UE as system information. An eNB may notify UE of a change of the uplink-downlink allocation state of a radio frame by transmitting only the index of uplink-downlink configuration information to the UE whenever the uplink-downlink configuration information is changed. Furthermore, configuration information is kind of downlink control information and may be transmitted through a Physical Downlink Control Channel (PDCCH) like other scheduling information. Configuration information may be transmitted to all UEs within a cell through a broadcast channel as broadcasting information.

Table 2 represents configuration (length of DwPTS/GP/UpPTS) of a special subframe.

TABLE 2

| | Normal cyclic prefix in | | | Extended cyclic prefix in | | |
|---|---|---|---|---|---|---|
| Special | | UpPTS | | | UpPTS | |
| subframe | downlink | Normal cyclic | Extended cyclic | downlink | Normal cyclic | Extended cyclic |
| configuration | DwPTS | prefix in uplink | prefix in uplink | DwPTS | prefix in uplink | prefix in uplink |
| 0 | 6592 · Tₛ | 2192 · Tₛ | 2560 · Tₛ | 7680 · Tₛ | 2192 · Tₛ | 2560 · Tₛ |
| 1 | 19760 · Tₛ | | | 20480 · Tₛ | | |
| 2 | 21952 · Tₛ | | | 23040 · Tₛ | | |
| 3 | 24144 · Tₛ | | | 25600 · Tₛ | | |
| 4 | 26336 · Tₛ | | | 7680 · Tₛ | 4384 · Tₛ | 5120 · Tₛ |
| 5 | 6592 · Tₛ | 4384 · Tₛ | 5120 · Tₛ | 20480 · Tₛ | | |
| 6 | 19760 · Tₛ | | | 23040 · Tₛ | | |
| 7 | 21952 · Tₛ | | | — | — | — |
| 8 | 24144 · Tₛ | | | — | — | — |

The structure of a radio subframe according to the example of FIG. 1 is just an example, and the number of subcarriers included in a radio frame, the number of slots included in a subframe and the number of OFDM symbols included in a slot may be changed in various manners.

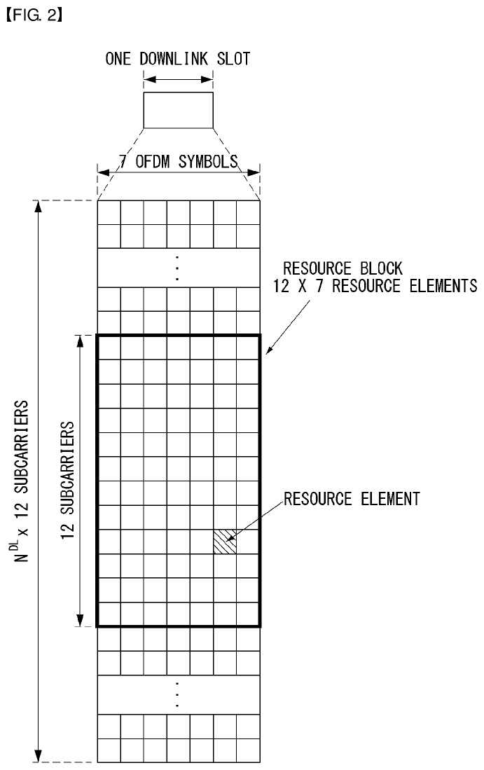

FIG. 2 is a diagram illustrating a resource grid for one downlink slot in a wireless communication system to which an embodiment of the present invention may be applied.

Referring to FIG. 2, one downlink slot includes a plurality of OFDM symbols in a time domain. It is described herein that one downlink slot includes 7 OFDMA symbols and one resource block includes 12 subcarriers for exemplary purposes only, and the present invention is not limited thereto.

Each element on the resource grid is referred to as a resource element, and one resource block (RB) includes 12×7 resource elements. The number of RBs N\hat{ }DL included in a downlink slot depends on a downlink transmission bandwidth.

The structure of an uplink slot may be the same as that of a downlink slot.

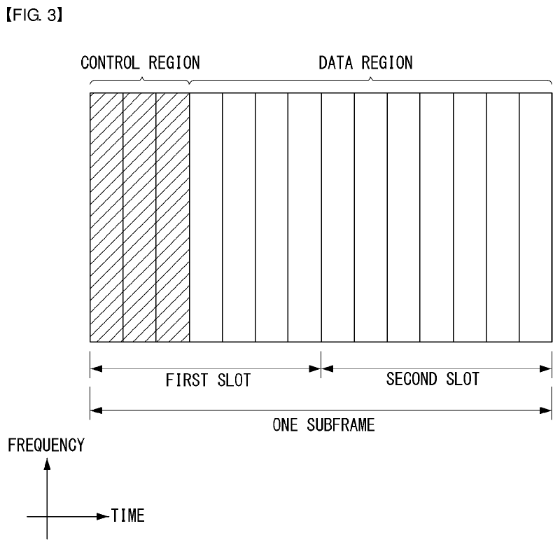

FIG. 3 shows the structure of a downlink subframe in a wireless communication system to which an embodiment of the present invention may be applied.

Referring to FIG. 3, a maximum of three OFDM symbols located in a front portion of a first slot of a subframe correspond to a control region in which control channels are allocated, and the remaining OFDM symbols correspond to a data region in which a physical downlink shared channel (PDSCH) is allocated. Downlink control channels used in 3GPP LTE include, for example, a physical control format indicator channel (PCFICH), a physical downlink control channel (PDCCH), and a physical hybrid-ARQ indicator channel (PHICH).

A PCFICH is transmitted in the first OFDM symbol of a subframe and carries information about the number of OFDM symbols (i.e., the size of a control region) which is used to transmit control channels within the subframe. A PHICH is a response channel for uplink and carries an acknowledgement (ACK)/not-acknowledgement (NACK) signal for a Hybrid Automatic Repeat Request (HARQ). Control information transmitted in a PDCCH is called Downlink Control Information (DCI). DCI includes uplink resource allocation information, downlink resource allocation information, or an uplink transmission (Tx) power control command for a specific UE group.

A PDCCH may carry information about the resource allocation and transport format of a downlink shared channel (DL-SCH) (this is also called an “downlink grant”), resource allocation information about an uplink shared channel (UL-SCH) (this is also called a “uplink grant”), paging information on a PCH, system information on a DL-SCH, the resource allocation of a higher layer control message, such as a random access response transmitted on a PDSCH, a set of transmission power control commands for individual UE within specific UE group, and the activation of a Voice over Internet Protocol (VoIP), etc. A plurality of PDCCHs may be transmitted within the control region, and UE may monitor a plurality of PDCCHs. A PDCCH is transmitted on a single Control Channel Element (CCE) or an aggregation of some contiguous CCEs. A CCE is a logical allocation unit that is used to provide a PDCCH with a coding rate according to the state of a radio channel. A CCE corresponds to a plurality of resource element groups. The format of a PDCCH and the number of available bits of a PDCCH are determined by an association relationship between the number of CCEs and a coding rate provided by CCEs.

An eNB determines the format of a PDCCH based on DCI to be transmitted to UE and attaches a Cyclic Redundancy Check (CRC) to control information. A unique identifier (a Radio Network Temporary Identifier (RNTI)) is masked to the CRC depending on the owner or use of a PDCCH. If the PDCCH is a PDCCH for specific UE, an identifier unique to the UE, for example, a Cell-RNTI (C-RNTI) may be masked to the CRC. If the PDCCH is a PDCCH for a paging message, a paging indication identifier, for example, a Paging-RNTI (P-RNTI) may be masked to the CRC. If the PDCCH is a PDCCH for system information, more specifically, a System Information Block (SIB), a system information identifier, for example, a System Information-RNTI (SI-RNTI) may be masked to the CRC. A Random Access-RNTI (RA-RNTI) may be masked to the CRC in order to indicate a random access response which is a response to the transmission of a random access preamble by UE.

The enhanced PDCCH (EPDCCH) carries UE-specific signaling. The EPDCCH is located in a physical resource block (PRB) that is configured to be UE specific. In other words, as described above, the PDCCH may be transmitted in up to three OFDM symbols in the first slot in the subframe, but the EPDCCH can be transmitted in a resource region other than the PDCCH. The time (i.e., symbol) at which the EPDCCH starts in the subframe may be set in the UE via higher layer signaling (e.g., RRC signaling, etc.).

The EPDCCH may carry a transport format, resource allocation, and HARQ information associated with DL-SCH, a transport format, resource allocation, and HARQ information associated with UL-SCH, resource allocation information associated with Sidelink Shared Channel (SL-SCH) and Physical Sidelink Control Channel (PSCCH), etc. Multiple EPDCCHs may be supported and the UE may monitor the set of EPCCHs.

The EPDCCH may be transmitted using one or more successive enhanced CCEs (ECCEs) and the number of ECCEs per EPDCCH may be determined for each EPDCCH format.

Each ECCE may be constituted by a plurality of enhanced resource element groups (EREGs). The EREG is used for defining mapping of the ECCE to the RE. There are 16 EREGs per PRB pair. All REs are numbered from 0 to 15 in the order in which the next time increases in the order in which the frequency increases, except for the RE carrying the DMRS in each PRB pair.

The UE may monitor a plurality of EPDCCHs. For example, one or two EPDCCH sets may be set in one PRB pair in which the UE monitors EPDCCH transmission.

Different coding rates may be implemented for the EPCCH by merging different numbers of ECCEs. The EPCCH may use localized transmission or distributed transmission, and as a result, the mapping of the ECCE to the RE in the PRB may vary.

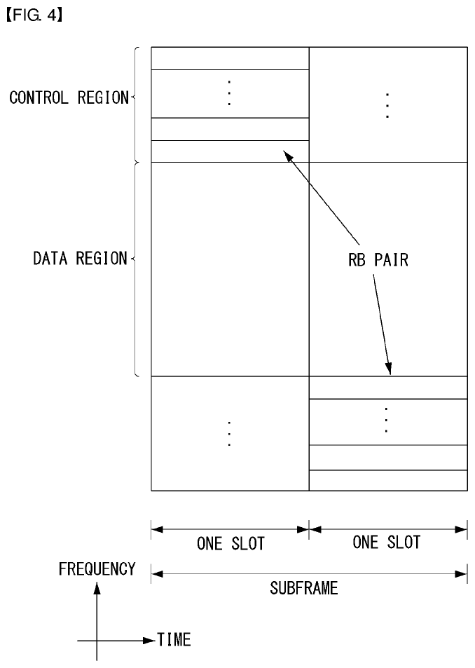

FIG. 4 shows the structure of an uplink subframe in a wireless communication system to which an embodiment of the present invention may be applied.

Referring to FIG. 4, the uplink subframe may be divided into a control region and a data region in a frequency domain. A physical uplink control channel (PUCCH) carrying uplink control information is allocated to the control region. A physical uplink shared channel (PUSCH) carrying user data is allocated to the data region. In order to maintain single carrier characteristic, one UE does not send a PUCCH and a PUSCH at the same time.

A Resource Block (RB) pair is allocated to a PUCCH for one UE within a subframe. RBs belonging to an RB pair occupy different subcarriers in each of 2 slots. This is called that an RB pair allocated to a PUCCH is frequency-hopped in a slot boundary.

Downlink Channel State Information (CSI) Feedback

In a current LTE standard, there are two transmission types of open-loop MIMO and closed-loop MIMO without channel information.

In the closed-loop MIMO, each of a transmitter and a receiver performs beamforming based on channel information, i.e., CSI in order to obtain a multiplexing gain of an MIMO antenna.

The eNB instructs the UE to allocate the Physical Uplink Control Channel (PUCCH) or the Physical Uplink Shared CHannel (PUSCH) and feed back the downlink CSI in order to obtain the CSI.

The CSI is roughly categorized into three information: Rank Indicator (RI), Precision Matrix Index (PMI), and Channel Quality Indication (CQI).

First, the RI represents rank information of a channel, which means the number of streams received by the UE through the same time-frequency resource.

Since this value is dominantly determined by long term fading of the channel, the value is fed back from the UE to the eNB with a period usually longer than the PMI and the CQI.

Next, the PMI is a value reflecting a channel space characteristic and represents a precoding index of the eNB preferred by the UE based on a metric such as SINR, etc.

Next, the CQI is a value representing the strength of the channel, and generally refers to a reception SINR that may be obtained when the eNB uses the PMI.

In a more advanced communication system such as LTE-A, additional multi-user diversity using multi-user MIMO (MU-MIMO) is added.

To this end, higher accuracy is required in terms of channel feedback.

The reason is that in the MU-MIMO, an interference channel exists between the UEs multiplexed in an antenna domain, so that feedback channel accuracy greatly affects not only the UE that raises the feedback but also the interference of other multiplexed UEs.

Accordingly, in LTE-A, it is determine to design a final PMI into W1 which is a long term and/or wideband PMI and W2 which is a short term and/or sub-band PMI in order to increase feedback channel accuracy.

A codebook is transformed by using a long-term covariance matrix of the channel as follows as an example of a hierarchical codebook transformation scheme configuring one final PMI from two channel information.

[Equation 1]

W=norm(W1W2) (1)

In Equation 1 above, W2 (=short term PMI) represents a codeword of a codebook created to reflect short-term channel information, W represents a codeword of a transformed final codebook, and norm(A) refers to a matrix in which a norm for each column in matrix is normalized to 1.

A specific structure of the existing W1 and W2 is described below.

$$W 1 ( i ) = [ \begin{matrix}{X}_{i} & 0 \\ 0 & {X}_{i}\end{matrix} ] , where {X}_{i} is Nt / 2 by M matrix . \\ W 2 ( j ) = \overbrace{[ \begin{matrix}{e}_{M}^{k} & {e}_{M}^{l} & & {e}_{M}^{m} \\ & & … & \\ {α}_{j} {e}_{M}^{k} & {β}_{j} {e}_{M}^{l} & & {γ}_{j} {e}_{M}^{m}\end{matrix} ]}^{r columns} \\ ( if rank = r ) , \\ where \\ 1 \leq k , l , m \leq M and k , l , m are integer . \qquad [ Equation 2 ]$$

The codeword structure is designed to reflect the correlation characteristics of channels using a cross polarized antenna and when a spacing between the antennas is narrow (usually when the distance between adjacent antennas is less than half of a signal wavelength).

In the case of the cross polarized antenna, the antenna may be divided into a horizontal antenna group and a vertical antenna group and each antenna group has a characteristic of a uniform linear array (ULA) antenna, and two antenna groups are co-located.

Therefore, a correlation between the antennas of each group has the same linear phase increment (LPI) characteristic, and the correlation between the antenna groups has a phase rotation characteristic.

Since the codebook is consequently a quantized value of the channel, it is necessary to design the codebook reflecting the characteristics of the channel corresponding to a source as it is. For convenience of description, it may be confirmed that the channel characteristic is reflected in a codeword satisfying Equation 2 by taking a rank 1 codeword made of the above structure as an example.

$$W 1 ( i ) * W 2 ( j ) = [ \begin{matrix}{X}_{i} ( k ) \\ {α}_{j} {X}_{i} ( k )\end{matrix} ] \qquad [ Equation 3 ]$$

In Equation 3 above, the codeword is expressed by a vector of Nt (the number of Tx antennas) by 1 and structured by both upper vector Xᵢ(k) and lower vector αᵢXᵢ(k), and each of vector shows correlation characteristics of a horizontal antenna group and a vertical antenna group.

It is advantageous that X_{z}(k) is expressed by a vector linear phase increment by reflecting correlation characteristics of antennas of each antenna group and as a representative example, a DFT matrix may be used.

Further, higher channel accuracy is required even for CoMP.

In case of CoMP JT, since several eNBs cooperatively transmit the same data to a specific UE, theoretically, the CoMP JT may be regarded as an MIMO system in which the antennas are geographically dispersed.

That is, in the case of MU-MIMO in JT, a high level of channel accuracy is required in order to avoid co-scheduling inter-UE interference like single cell MU-MIMO.

Further, in the case of CoMP CB, sophisticated channel information is also required to avoid interference which an adjacent cell gives to the serving cell.

Restricted RLM and RRM/CSI Measurement

As a method for interfering coordination, an aggressor cell may use a silent subframe (may be referred to as almost blank subframe (ABS) that reduces transmission power/activity of some physical channels (including even an operation of setting transmission power/activity to zero power) and a victim cell may perform time domain inter-cell interference coordination of scheduling the UE by considering the silent subframe.

In this case, the interference level may vary greatly depending on the subframe in the victim cell UE.

In this case, in order to perform a radio resource management (RRM) operation to measure more accurate radio link monitoring (RLM) or RSRP/RSRQ in each subframe or to measure channel state information (CSI) for link adaptation, the monitoring/measurement needs to be limited to sets of subframes having uniform interference characteristics.

In the 3GPP LTE system, restricted RLM and RRM/CSI measurements are defined as below.

UE Procedure for Reporting Channel State Information (CSI)

Time and frequency resources may be used by the UE in order to report a CSI constituted by the CQI, the PMI, and/or the RI controlled by the eNB.

For spatial multiplexing, the UE needs to determine the RI corresponding to the number of transmission layers.

In this case, the RI is equal to 1 for transmission diversity.

When the UE is set to transmission mode 8 or 9, the UE may perform or not perform PMI/RI reporting by a higher layer parameter pmi-RI-Report.

When the subframe is configured in the upper layer as c_{CSI,0} and c_{CSI,1}, the UE may be configured with resource-restricted CSI measurements.

In this case, CSI reporting may be periodic or aperiodic.

When the UE is constituted by one or more serving cells, the CSI may be transmitted only in an activated serving cell.

When the UE is not configured for PUSCH and PUCCH transmission at the same time, the UE needs to periodically report the CSI for the PUCCH in a subframe in which the PUSCH is not allocated as described later.

When the UE is not configured for the PUSCH and PUCCH transmission at the same time, the UE needs to report a periodic CSI for the PUSCH of a serving cell having the minimum servcell index in a subframe in which the PUSCH is allocated.

In this case, the UE needs to use a periodic CSI reporting format based on the same PUCCH for the PUSCH.

When the UE satisfies a specific condition stated thereafter, the UE needs to perform aperiodic CSI reporting through the PUSCH.

Aperiodic CQI/PMI reporting and RI reporting are transmitted only when a CSI feedback type supports the RI reporting.

A set of UE subbands may evaluate CQI reporting corresponding to an entire downlink system bandwidth.

The subband is a set constituted by k PRBs and in this case, k is a function of a system bandwidth.

In a last subband of S set, the number of consecutive PRBs may be smaller than k according to N_{RB}^{DL}.

The number of system bandwidths given by N_{RB}^{DL} may be defined as N=┌N_{RB}^{DL}/k┐.

The subbands need to be indexed in an order in which the frequency increases from the minimum frequency and in an order in which the size does not increase.

Table 3 is a table showing a subband size (k) and a configuration of the system bandwidth.

TABLE 3

| System Bandwidth | Subband Size |
|---|---|
| N_{RB}^{DL} | (k) |
| 6-7 | NA |
| 8-10 | 4 |
| 11-26 | 4 |
| 27-63 | 6 |
| 64-110 | 8 |

Aperiodic CSI Reporting Using PUSCH

When the UE performs decoding in subframe n, the UE may perform aperiodic CSI reporting of any one of the followings by using subframe n+k PUSCH of serving cell c.

an uplink DCI format, or

a Random Access Response Grant,

When respective CSI request fields are configured to trigger the report and are not reserved, the respective CSI request fields are used for providing serving cell C.

When the CSI request field is 1 bit, the CSI request field is set to 1 and a report for serving cell c is triggered.

When the CSI request field size is 2 bits, the report is triggered according to the value of Table 4.

The UE does not expect to receive one or more aperiodic CSI report request for a given subframe.

Table 4 shows a CSI request field for a PDCCH having an uplink

DCI format in a search space.

TABLE 4

| Value of CSI request field | Description |
|---|---|
| ’00’ | No aperiodic CSI report is triggered |
| ‘01’ | Aperiodic CSI report is triggered for |
| | serving cell ^{c} |
| ‘10’ | Aperiodic CSI report is triggered for a 1st |
| | set of serving cells configured by higher |
| | layers |
| ‘11’ | Aperiodic CSI report is triggered for a |
| | 2nd set of serving cells configured by |
| | higher layers |

Feedback Timing Configuration for Various CSIs

In 3GPP LTE, aperiodic feedback of channel state information (CSI) may be made after 4 ms/5 ms (or a subsequent initial available UL subframe) from a subframe (i.e., a reference resource) in which an aperiodic CSI request is received.

However, it is desirable that the feedback of the CSI is performed in a shorter time (e.g., less than milliseconds) than the existing LTE, in order to prevent a CSI aging effect and to reduce the latency.

Therefore, to this end, it is considered that the eNB directly dynamically designates (CSI) feedback timing to the UE.

The reason is that in particular, a CSI calculation time is different depending on a case.

Here, the CSI calculation time means a time required for the UE to derive the CSI assuming the reference resource from a CSI reference resource.

For example, the CSI calculation time required by the UE may vary depending on whether the UE calculates CSI for one wideband (or subband) or calculates all CSIs for a plurality of carrier components/subbands.

Accordingly, the present disclosure proposes a scheme in which the eNB sets different feedback timings for the UE according to contents (e.g., feedback type, bandwidth granularity, and UE calculation capability) to be fed back in the corresponding CSI feedback.

Designation of CSI Feedback Timing According to Feedback Contents

In the present disclosure, the CSI feedback timing is defined as a time up to a UL resource in which the UE feeds back an actual CSI from the (aperiodic) CSI request.

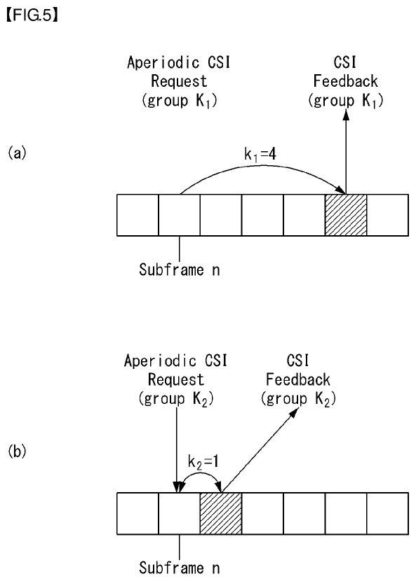

That is, like k₁ and k₂ illustrated in FIG. 5, the CSI feedback timing means that how long resource allocation for the CSI report corresponds to/is applied to a resource which is far away from a transmission time n of the aperiodic CSI request is designated.

This may be a symbol unit or a subframe unit and may be defined as a unit such as an absolute time or a mini subframe considered in new RAT.

Further, hereinafter, an (aperiodic) CSI request receiving time may be replaced with a subframe defined as a reference resource.

The meaning that the CSI feedback timing is defined as the absolute time means that a given timing may be interpreted as another unit which corresponds to the relevant timing according to numerology.

For example, the system may support a band a subcarrier spacing which is t times (t=1, 2, 3, . . . ) of 15 kHz and a timing value in a subcarrier spacing 15 kHz band is signaled in k (symbol unit).

In this case, it may be defined as t*k according to a t value of different carrier spacing (e.g., 15 kHz carrier spacing:k, 30 kHz carrier spacing:k*2, 60 kHz carrier spacing: k*4).

When different numbers of symbols form one subframe in each carrier spacing, the number of corresponding symbols in the band using each carrier spacing may be similarly considered.

For example, in the subcarrier spacing 15 kHz band, 14 symbols may form one subframe in symbol duration T and in a subcarrier spacing 30 kHz band, 28 symbols may form one subframe in symbol duration T/2.

In this case, when k in the subcarrier spacing 15 kHz band is defined in unit of the symbol, the corresponding timing may be interpreted as 15 kHz:k and 30 kHz:2*k and when k is defined in unit of the subframe, the corresponding timing may be interpreted as 15 kHz:k and 30 kHz:k.

Hereinafter, a scheme of classifying the group according to wideband/subband reporting as described when determining a group depending on frequency granularity for the CSI reporting proposed by the present disclosure will be described.

Moreover, a method for defining/setting the group differently depending on a set size of the subband will be described in the present disclosure.

First, in respect to a subband size, a separate subband size to be used in the corresponding CSI reporting may be set through higher-layer signaling such as RRC in the same scheme as N RBs or N subbands.

When such a scheme is, in particular, CSI reporting for a group in which only a small amount of time is given for CSI reporting, the corresponding reporting timing may be satisfied and partial subband CSI information may be reported from the UE through a scheme of additionally configuring the corresponding parameter other than the wideband reporting.

Alternatively, like a scheme to be described below, when specific CSI reporting timing (in particular, short timing) is signaled, the UE may operate by interpreting that the UE performs subband reporting using a subband with a set size instead of the existing subband size as the corresponding reporting.

For the same purpose, the subband size may be configured as the same meaning as 1/N′ for entire frequency granularity to be reported, such as a wideband/partial band/bandwidth part instead of an actual length.

The reason is that the CSI reporting timing is greatly affected by the number of subbands to be reported for CSI calculation.

For example, when the entire frequency region is defined as a total of M RBs, the size of the subband may be defined as ┌M/N′┐ (the size of a last subband is constituted by remaining RBs).

Similarly, a subband group to be subject to actual reporting among all target subbands of CSI reporting may be set.

In other words, the UE performs CSI reporting only for the set subband group and does not perform CSI reporting for the remaining subbands.

To this end, the eNB may configure a pattern of a subband to actually calculate/report the CSI to the UE.

For example, when the size of the entire frequency granularity which becomes the target of the CSI reporting, such as the wideband/partial band/bandwidth part is N RBs or N subbands, an N-bit bitmap may be defined and an RRC configuration in which an RB or subband to calculate/report actual CSI is configured as a bitmap may be transmitted to the UE.

For more effective configuration, the eNB may set a subband spacing SB_{P} to the UE through the higher-layer signaling such as RRC and set the group differently according to the value of the corresponding SB_{P}.

This may be interpreted as a density of a subband to be reported and comb type subbands having an interval as large as SB_{P} are included in the corresponding subband group.

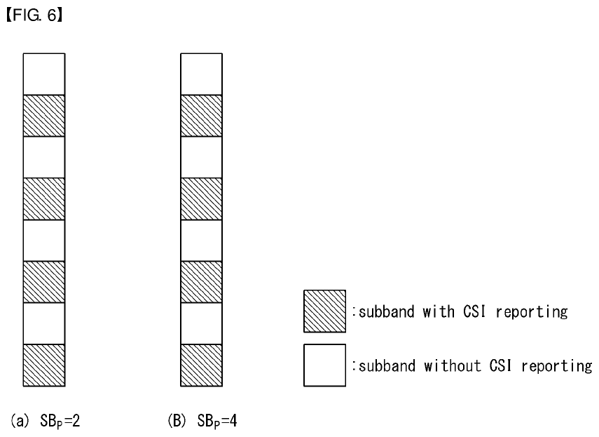

As illustrated in FIG. 6, for example, when SB_{P}=4, a comb type in which a repetition factor (RPF)=4 may be, for example, a scheme of calculating/reporting the CSI only for a subband in which (subband index) mod 4=0.

In particular, since a case of SB_{P}=1 is a general subband reporting scheme, the case of SB_{P}=1 may be included in a different group from the wideband reporting.

In this case, an offset for comb is simultaneously set to designate a subband group to be actually used among subband groups determined as the same SB_{P}.

Alternatively, for convenience of configuration, the subband group may be defined as a subband group for a specific offset value, e.g., (subband index) mod 4=0 in advance.

Similarly, in order to more conveniently adjust desired CSI reporting timing, the maximum number SB_{N} of subbands to be subject to subband reporting may be set through the higher-layer signaling instead of the interval between the subbands.

In this case, a scheme of performing the CSI reporting for SB_{N} subbands having the same spacing is used with respect to the entire frequency granularity to be subject to CSI reporting, such as the wideband/partial band/bandwidth part.

For example, when a total of M subbands of the entire frequency region are defined, the interval between the subbands may be defined as ┌M/SB_{N}┐.

If such a scheme is used, when the eNB indicates specific timing (in particular, short timing) for the CSI reporting, the eNB may perform the CSI reporting with respect of SB_{N} subbands connected/set at the corresponding reporting timing.

Further, by constantly setting the interval between the subbands, there is an effect that balanced channel estimation is available across the band without biasing on either side.

The aforementioned scheme means a scheme of redefining the corresponding subband size by the aforementioned scheme when there is a separately defined or signaled subband size.

In order to more clearly indicate such an operation to the UE, the eNB may explicitly indicate the subband re-sizing or subband reporting omitting operation dynamically through MAC CE or DCI apart from an aperiodic CSI reporting request.

In order to satisfy the reporting timing and preponderantly receive subband reporting for a specific region, the eNB may additionally designate a frequency region to be subject to the CSI reporting in addition to the subband group related signaling.

This may be used as a scheme for satisfying the number of subbands to calculate/report the CSI and indicating localized CSI feedback for a specific region to the UE.

To this end, the eNB may set an offset for the corresponding CSI feedback frequency region to the UE through a higher-layer signaling scheme such as RRC.

In such a case, the UE performs reporting of SB_{N} subbands from a designated offset.

In order to determine the subband to be subject to the CSI reporting, the eNB may set a threshold of SINR through the RRC signaling and the UE calculates/reports the CSI only for a subband which is more than a set SINR threshold among measured subband SINRs.

This is a scheme that allows the UE to calculate/report only a subband having a possibility of subband scheduling to reduce a time required for actually calculating/reporting the CSI.

Alternatively, the eNB may set the SB_{N} (the maximum number of subbands to be subject to the CSI reporting) to the UE and report CSI for upper SB_{N} subbands based on the SINR among all subbands.

In order to more accurately use the aforementioned scheme, the eNB may select the subband based on a CQI instead of the SINR.

In other words, in the aforementioned scheme, a CQI threshold may be set instead of an SINR threshold and the UE may report CSI for a subband which is more than the corresponding CQI threshold or report CSI for upper SB_{N} subbands based on the CQI among all subbands.

Such a scheme may be used only for a case where it does not take much time to calculate the CQI, e.g., a case such as rank 1/2 port.

The UE may report whether CSI subband reporting for the SINR or/and CQI threshold is performed to the eNB in advance in the form of a UE capability.

The UE and the eNB may determine whether to apply the aforementioned technique based on the reported UE capability and the designated timing.

In the case of semi-persistent CSI reporting, the aforementioned operation may be used with respect to N slot (e.g., N=2) after the corresponding CSI reporting is activated.

The reason is that since a time to calculate the corresponding CSI from a designated RS is short just after the corresponding CSI reporting is enabled, it is preferable to reduce a time required for the CSI reporting by using the aforementioned scheme.

In actual application of the above technique, the above techniques may be applied alone or in combination.

Further, in the above patent, for convenience of description, the proposed scheme based on the 3GPP LTE system has been described, but the scope of the system to which the proposed method is applied may be extended to other systems (e.g., UTRA, etc.) than the 3GPP LTE system, in particular 5G and candidate technology thereof.

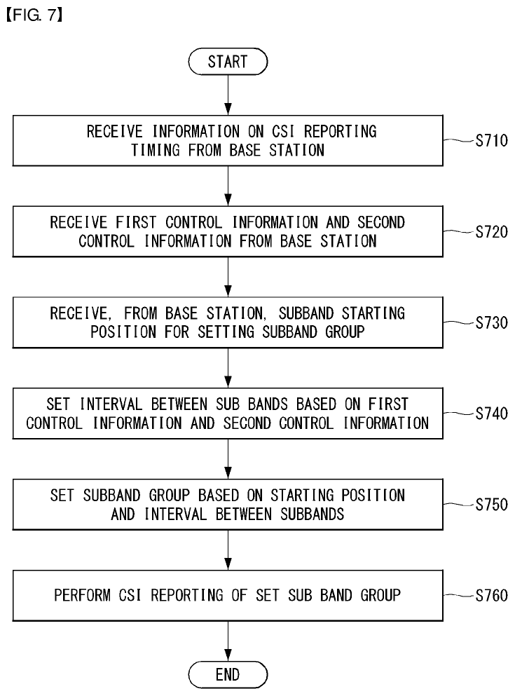

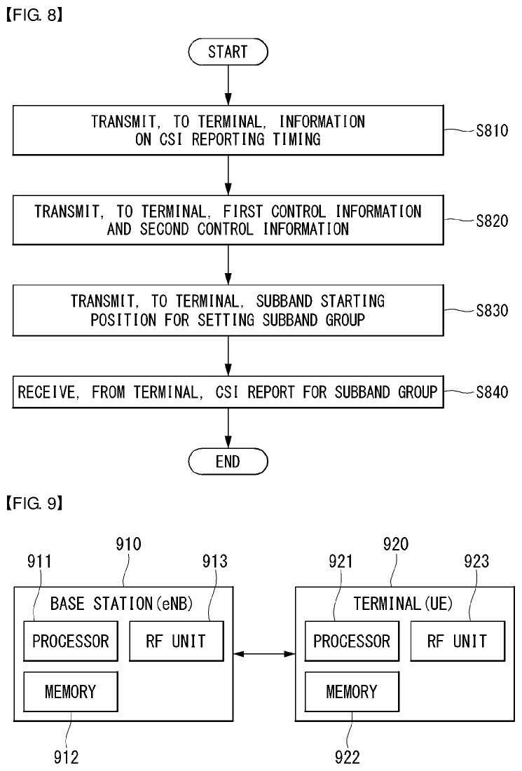

Next, the method for performing CSI-RS reporting proposed in the present disclosure will be described in more detail with reference to FIGS. 7 and 8 which are related drawings.

FIG. 7 is a flowchart illustrating one example of an operation method of a UE performing CSI-RS reporting based on a subband group proposed in the present disclosure.

First, the UE receives information on CSI reporting timing from an eNB (S710).

In addition, the UE receives first control information and second control information from the eNB (S720).

In this case, the first control information means information on a frequency region to be subject to subband reporting and the second control information means information on the maximum number of subbands to be subject to the subband reporting.

In addition, the UE receives, from the eNB, a subband starting position for setting the subband group (S730).

In addition, the UE sets an interval between subbands based on the first control information and the second control information.

In addition, the UE sets a subband group based on the starting position and the interval.

Here, the subband group means a subband to be subject to CSI reporting in the subbands.

In addition, the UE performs CSI reporting of the set subband group (S760).

FIG. 8 is a flowchart illustrating one example of an operation method of an eNB performing CSI-RS reporting based on a subband group proposed in the present disclosure.

First, the eNB transmits, to the UE, information on CSI reporting timing (S810).

In addition, the eNB transmits, to the UE, first control information and second control information (S820).

In this case, the first control information and the second control information are the same as the first control information and the second control information described in FIG. 7.

In addition, the eNB transmits, from the UE, a subband starting position for setting the subband group (S830).

In addition, the eNB receives, from the UE, a CSI report for the subband group (S840).

In this case, the CSI report received in step S840 means a CSI reporting value for the subband group according to steps S710 to S760 of FIG. 7.

General Apparatus to which the Present Invention May be Applied

FIG. 9 illustrates a block diagram of a wireless communication apparatus according to an embodiment of the present invention.

Referring to FIG. 9, the wireless communication system includes a base station (eNB) 910 and a plurality of user equipments (UEs) 920 located within the region of the eNB 910.

The eNB 910 includes a processor 911, a memory 912 and a radio frequency unit 913. The processor 911 implements the functions, processes and/or methods proposed in the preceding FIGS.

The layers of wireless interface protocol may be implemented by the processor 1611.

The memory 1612 is connected to the processor 1611, and stores various types of information for driving the processor 1611.

The RF unit 1613 is connected to the processor 1611, and transmits and/or receives radio signals.

The UE 1620 includes a processor 1621, a memory 1622 and a radio frequency unit 1623.

The processor 1621 implements the functions, processes and/or methods proposed in the preceding FIGS.

The layers of wireless interface protocol may be implemented by the processor 1621.

The memory 1622 is connected to the processor 1621, and stores various types of information for driving the processor 1621.

The RF unit 1623 is connected to the processor 1621, and transmits and/or receives radio signals.

The memories 1612 and 1622 may be located interior or exterior of the processors 1611 and 1621, and may be connected to the processors 1611 and 1621 with well known means.

In addition, the eNB 1610 and/or the UE 1620 may have a single antenna or multiple antennas.

The embodiments described so far are those of the elements and technical features being coupled in a predetermined form. So far as there is not any apparent mention, each of the elements and technical features should be considered to be selective. Each of the elements and technical features may be embodied without being coupled with other elements or technical features. In addition, it is also possible to construct the embodiments of the present invention by coupling a part of the elements and/or technical features. The order of operations described in the embodiments of the present invention may be changed. A part of elements or technical features in an embodiment may be included in another embodiment, or may be replaced by the elements and technical features that correspond to other embodiment. It is apparent to construct embodiment by combining claims that do not have explicit reference relation in the following claims, or to include the claims in a new claim set by an amendment after application.

The embodiments of the present invention may be implemented by various means, for example, hardware, firmware, software and the combination thereof. In the case of the hardware, an embodiment of the present invention may be implemented by one or more application specific integrated circuits (ASICs), digital signal processors (DSPs), digital signal processing devices (DSPDs), programmable logic devices (PLDs), field programmable gate arrays (FPGAs), a processor, a controller, a micro controller, a micro processor, and the like.

In the case of the implementation by the firmware or the software, an embodiment of the present invention may be implemented in a form such as a module, a procedure, a function, and so on that performs the functions or operations described so far. Software codes may be stored in the memory, and driven by the processor. The memory may be located interior or exterior to the processor, and may exchange data with the processor with various known means.

It will be understood to those skilled in the art that various modifications and variations can be made without departing from the essential features of the inventions. Therefore, the detailed description is not limited to the embodiments described above, but should be considered as examples. The scope of the present invention should be determined by reasonable interpretation of the attached claims, and all modification within the scope of equivalence should be included in the scope of the present invention.

### INDUSTRIAL APPLICABILITY

Although a scheme of setting a subband group in a wireless communication system of the present invention has been described with reference to an example applied to a 3GPP LTE/LTE-A system or a 5G system (New RAT system), the scheme may be applied to various wireless communication systems in addition to the 3GPP LTE/LTE-A system or 5G system.

1. A method for reporting channel state information (CSI) in a wireless communication system, the method performed by a terminal, comprising:
receiving information on CSI reporting timing from a base station;
receiving, from the base station, first control information, which is information on a frequency region to be subject to subband reporting and second control information, which is information on a maximum number of subbands to be subject to subband reporting;
receiving, from the base station, information on a subband starting position for setting a subband group;
setting an interval between subbands based on the first control information and the second control information;
setting a subband group based on an interval between the starting position and the interval between the subbands; and
performing CSI reporting of the set subband group,
wherein the subband group is a subband to be subject to CSI reporting in the subbands.

2. The method of claim 1, further comprising:
receiving, from the base station, information on a subband size to be used for the CSI reporting through a higher-layer signaling,
wherein the subband group is determined based on the subband size.

3. The method of claim 1, wherein the second control information is determined based on the received CSI-reporting timing.

4. The method of claim 1, wherein the interval is floor (first control information/second control information).

5. The method of claim 1, further comprising:
transmitting capability information of the terminal;
receiving a reference value of SINR or CQI from a base station; and
measuring the SINR or CQI of a subband,
wherein in the setting of the subband group, the measured SINR or CQI and the reference value are compared with each other to set a subband in which the measured SINR or CQI is equal to or larger than the reference value as a subband group.

6. The method of claim 5, wherein whether to set the subband group is determined based on the capability of the terminal and the received CSI timing.

7. A terminal for performing a method for setting a subband group to be subject to CSI reporting based on CSI reporting timing in a wireless communication system, the terminal comprising:
a radio frequency (RF) module transmitting and receiving a radio signal; and
a processor functionally connected with the RF module,
wherein the processor is configured to
receive information on CSI reporting timing from a base station,
receive, from the base station, first control information, which is information on a frequency region to be subject to subband reporting and second control information, which is information on a maximum number of subbands to be subject to subband reporting,
receive, from the base station, information on a subband starting position for setting a subband group,
set an interval between subbands based on the first control information and the second control information,
set a subband group based on an interval between the starting position and the interval between the subbands, and
perform CSI reporting of the set subband group.

8. The terminal of claim 7, wherein the processor is configured to receive, from the base station, information on a subband size to be used for the CSI reporting through a higher-layer signaling, and
wherein the subband group is determined based on the subband size.

9. The terminal of claim 7, wherein the second control information is determined based on the received CSI-reporting timing.

10. The terminal of claim 7, wherein the interval is floor (first control information/second control information).

11. The terminal of claim 7, wherein the processor is configured to
transmit capability information of the terminal,
receive a reference value of SINR or CQI from a base station, and
measure the SINR or CQI of a subband, and
wherein in the setting of the subband group, the measured SINR or CQI and the reference value are compared with each other to set a subband in which the measured SINR or CQI is equal to or larger than the reference value as a subband group.

12. The terminal of claim 11, wherein whether to set the subband group is determined based on the capability of the terminal and the received CSI timing.
